(19) United States
(12) Patent Application Publication
(10) Pub. No.: US 2013/0057520 A1
(43) Pub. Date: Mar. 7, 2013

(54) DISPLAY, TIMING CONTROLLER AND OPERATION METHOD THEREOF

(71) Applicants: Chung-Chih Hsiao, Taoyuan County (TW); Chih-Jung Chien, Taoyuan County (TW)

(72) Inventors: Chung-Chih Hsiao, Taoyuan County (TW); Chih-Jung Chien, Taoyuan County (TW)

(73) Assignee: CHUNGHWA PICTURE TUBES, LTD., Taoyuan (TW)

(21) Appl. No.: 13/306,953

(22) Filed: Nov. 29, 2011

(30) Foreign Application Priority Data
Sep. 1, 2011 (TW) 100131529

(51) Int. Cl. G06F 3/038

(52) U.S. Cl. 345/204

(57) ABSTRACT

A display, a timing controller, and an operation method thereof are provided. The operation method includes following steps. A first row image data and a second row image data are received sequentially. A row display data and a horizontal clock signal are outputted according to the first row image data. The first row image data and the second row image data are compared. When the first row image data and the second row image data are equal, the output of the horizontal clock signal and the row display data generated based on the second row image data discontinues. When the first row image data and the second row image data are not equal, the horizontal clock signal and the row display data generated based on the second row image data are outputted.

### CROSS-REFERENCE TO RELATED APPLICATION

This application claims the priority benefit of Taiwan application serial no. 100131529, filed on Sep. 1, 2011. The entirety of the above-mentioned patent application is hereby incorporated by reference herein and made a part of this specification.

### BACKGROUND OF THE INVENTION

1. Field of the Invention

The invention relates to a controller and an operation method thereof. More particularly, the invention relates to a display, a timing controller, and an operation method thereof.

2. Description of Related Art

In recent years, thin film transistor liquid crystal displays (TFT-LCDs) have been widely employed, and the TFT-LCDs have replaced the conventional cathode ray tube (CRT) displays and become a mainstream display of the forthcoming displays. With improvement in the semiconductor technology, the TFT-LCD has the advantages of low power consumption, slimness and compactness, high resolution, high color saturation, long life span, and so forth. Therefore, the TFT-LCD has been extensively applied to electronic products closely related to our daily lives, such as liquid crystal screens of computers and liquid crystal display televisions (LCD TVs).

In general, an LCD includes a timing controller, a source driver, a gate driver, and an LCD panel. After receiving an image data, the timing controller generates a display data, a clock signal, a polarity signal, and a latch signal based on the image data and transmits the display data, the clock signal, the polarity signal, and the latch signal to the source driver. The source driver, based on the received display data, the received clock signal, the received polarity signal, and the received latch signal, outputs corresponding pixel voltages to the LCD panel. The gate driver outputs scan signals to the LCD panel to turn on pixels of the LCD panel. The turned-on pixels receive the pixel voltages to display images. In view of the above, the timing controller, after continuously receiving the image data, keeps on outputting the display data, the clock signal, the polarity signal, and the latch signal to the source driver, thus leading to the difficulty in reduction of power consumption of the timing controller.

### SUMMARY OF THE INVENTION

The invention is directed to a display, a timing controller, and an operation method thereof. When a first row image data and a second row image data that are sequentially received are equal, a horizontal clock signal and a row display data generated based on the second row image data are not outputted, so as to reduce the power consumption of the timing controller.

In an embodiment of the invention, a display that includes a display panel, a timing controller, a gate driver, and a source driver is provided. The timing controller sequentially receives a first row image data and a second row image data for generating a row display data, a polarity control signal, and a latch signal based on the first row image data or the second row image data. When the first row image data and the second row image data are equal, the timing controller stops outputting the row display data generated based on the second row image data. The gate driver is coupled to the timing controller and the display panel for outputting a plurality of scan signals to the display panel. The source driver is coupled to the timing controller and the display panel for outputting a plurality of pixel voltages to the display panel based on the row display data, the polarity control signal, and the latch signal.

In an embodiment of the invention, a timing controller that includes a line buffer, a data processing unit, and a data comparing unit is provided. The line buffer sequentially receives the first row image data and the second row image data. The data processing unit is coupled to the line buffer for generating the row display data based on the first row image data or the second row image data. The data comparing unit is coupled to the line buffer for comparing the first row image data with the second row image data and outputting a comparison result to the data processing unit. When the first row image data and the second row image data are equal, the timing controller, according to the comparison result, stops outputting the row display data generated based on the second row image data.

According to an embodiment of the invention, the timing controller further includes a data inputted latch that is coupled to the line buffer for determining whether the first row image data and the second row image data are inputted to the line buffer.

According to an embodiment of the invention, the first row image data, the second row image data, and the row display data are transmitted through a differential signal.

According to an embodiment of the invention, the timing controller further includes a differential signal receiver and a differential signal transmitter. The differential signal receiver receives the first row image data and the second row image data in a form of the differential signal and outputs the first row image data and the second row image data to the line buffer. The differential signal transmitter receives the row display data from the data processing unit and outputs a horizontal clock signal and the row display data in the form of the differential signal. Based on an image clock signal, the differential signal receiver sequentially receives the first row image data and the second row image data.

According to an embodiment of the invention, the timing controller further includes a control signal generating unit that is coupled to the data processing unit. The control signal generating unit is controlled by the data processing unit to generate a latch signal and a polarity control signal.

In an embodiment of the invention, an operation method of a timing controller is provided, and the operation method includes following steps. a first row image data and a second row image data are received sequentially. A row display data and a horizontal clock signal are outputted according to the first row image data. The first row image data and the second row image data are compared. When the first row image data and the second row image data are equal, the output of the horizontal clock signal and the row display data generated based on the second row image data discontinues. When the first row image data and the second row image data are not equal, the horizontal clock signal and the row display data generated based on the second row image data are outputted.

According to an embodiment of the invention, the operation method of the timing controller further includes: generating a latch signal and a polarity control signal based on the first row image data and the second row image data.

According to an embodiment of the invention, the step of sequentially receiving the first row image data and the second row image data includes: sequentially receiving the first row image data and the second row image data based on an image clock signal.

As described in the above-mentioned embodiments with respect to the display, the timing controller, and the operation method thereof, when the second row image data and the first row image data are equal, the timing controller does not outputted the row display data generated based on the second row image data, so as to reduce the power consumption of the timing controller.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view illustrating a system of a display according to an embodiment of the invention.

FIG. 1B is a schematic view illustrating a system of a timing controller in the display shown in FIG. 1A according to an embodiment of the invention.

FIG. 2 is a schematic view illustrating timing of a timing controller in the display shown in FIG. 1A according to an embodiment of the invention.

FIG. 3 is a flowchart illustrating an operation method of a timing controller according to an embodiment of the invention.

### DETAILED DESCRIPTION OF DISCLOSED EMBODIMENTS

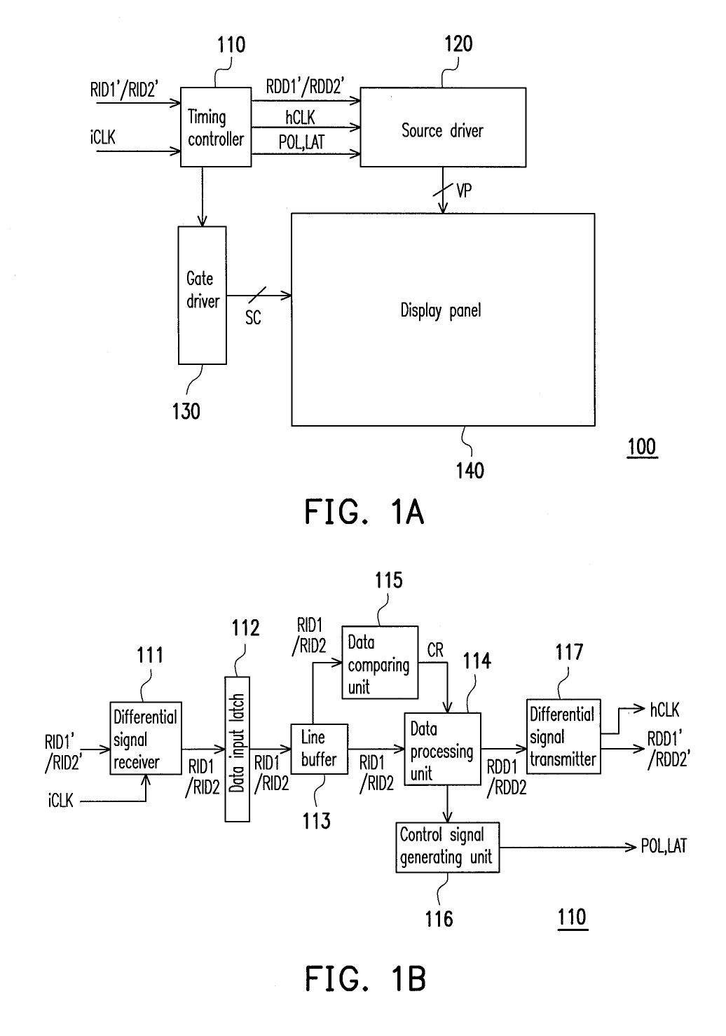

FIG. 1A is a schematic view illustrating a system of a display according to an embodiment of the invention. With reference to FIG. 1A, in this embodiment, the display 100 includes a timing controller 110, a source driver 120, a gate driver 130, and a display panel 140. The source driver 120 is coupled to the timing controller 110 and the display panel 140. The gate driver 130 is coupled to the timing controller 110 and the display panel 140. The gate driver 130 is controlled by the timing controller 110 to outputted a plurality of scan signals SC to the display panel 140, so as to turn on some pixels (not shown) in the display panel 140. In this embodiment, a row image data and a row display data are assumed to be transmitted through a differential signal.

When the timing controller 110, according to an image clock signal iCLK, receives a first row image data (i.e., row image data RID1′) in the form of the differential signal, the timing controller 110, based on the row image data RID1′, generates a first row display data (i.e., row display data RDD1′) in the form of the differential signal, and the timing controller 110 outputs a horizontal clock signal hCLK, a polarity control signal POL, and a latch signal LAT to the source driver 120. The source driver 120 receives the row display data RDD1′ based on the horizontal clock signal hCLK and outputs a plurality of pixel voltages VP to the display panel 140 based on the row display data RDD1′, the polarity control signal POL, and the latch signal LAT, such that the pixel voltages VP are written into the turned-on pixels. Here, the polarity control signal POL serves to control the polarity of the pixel voltages VP.

When the timing controller 110 receives a second row image data (i.e., row image data RID2′) in the form of the differential signal based on the image clock signal iCLK, the timing controller 110 compares the row image data RID1′ and RID2′. When the row image data RID1′ and RID2′ are equal, it indicates that the display effects of the row image data RID1′ and RID2′ are the same, i.e., the data contents of the row image data RID1′ and RID2′ are equivalent. At this time, the timing controller 110 stops outputting the horizontal clock signal hCLK and a second row display data (i.e., row display data RDD2′) in the form of the differential signal (the row display data RDD2′ and the horizontal clock signal hCLK are generated based on the row image data RID2′), while the timing controller 110 outputs the polarity control signal POL and the latch signal LAT to the source driver 120. It is not necessary for the source driver 120 to update the pixel voltages VP. Therefore, the timing controller 110 does not outputted the horizontal clock signal hCLK and the row display data RDD2′, whereas the source driver 120 cannot outputted the correct pixel voltages VP without the polarity control signal POL and the latch signal LAT. Hence, the timing controller 110 still outputs the polarity control signal POL and the latch signal LAT based on the row image data RID2′, so as to allow the source driver 120 to output the pixel voltages VP (generated based on the row display data RDD1′) to the display panel 140. The pixel voltages VP are then written into the turned-on pixels. Thereby, the power consumption of the timing controller 110 on the output of the row display data RDD2′ and the horizontal clock signal hCLK can be reduced.

When the row image data RID1′ and RID2′ are not equal, the row display data RDD2′, the horizontal clock signal hCLK, the polarity control signal POL, and the latch signal LAT are outputted to the source driver 120. The source driver 120 receives the row display data RDD2′ based on the horizontal clock signal hCLK and outputs a plurality of pixel voltages VP to the display panel 140 based on the row display data RDD2′, the polarity control signal POL, and the latch signal LAT, such that the pixel voltages VP are written into the turned-on pixels.

FIG. 1B is a schematic view illustrating a system of a timing controller in the display shown in FIG. 1A according to an embodiment of the invention. With reference to FIG. 1B, in this embodiment, the timing controller 110 includes a differential signal receiver 111, a data input latch 112, a line buffer 113, a data processing unit 114, a data comparing unit 115, a control signal generating unit 116, and a differential signal transmitter 117. The differential signal receiver 111 is coupled to the data input latch 112. The data input latch 112 is coupled to the line buffer 113. The line buffer 113 is coupled to the data processing unit 114 and the data comparing unit 115. The data processing unit 114 is coupled to the data comparing unit 115, the control signal generating unit 116, and the differential signal transmitter 117.

The differential signal receiver 111 sequentially receives the row image data RID1′ and RID2′ based on the image clock signal iCLK and sequentially outputs the row image data RID1 and RID2 to the data input latch 112. Here, the row image data RID1 and RID2 can be in a form of an inter integrated circuit (12C) signal or a general purpose input output (GPIO) signal.

The data input latch 112 serves to determine whether the row image data RID1 and RID2 are inputted to the line buffer 113. Namely, when the data input latch 112 is turned off, the row image data RID1 and RID2 are not transmitted to the line buffer 113. On the contrary, when the data input latch 112 is turned on, the row image data RID1 and RID2 are transmitted to the line buffer 113. The line buffer 113 transmits the row image data RID1 and RID2 to the data processing unit 114 and the data comparing unit 115. When the data comparing unit 115 receives the row image data RID1 and RID2, the data comparing unit 115 compares the row image data RID1 and RID2 and outputs the comparison result CR to the data processing unit 114.

When the data processing unit 114 receives the row image data RID1, the data processing unit 114 generates the row display data RDD1 based on the row image data RID1 and controls the control signal generating unit 116 to generate the polarity control signal POL and the latch signal LAT. When the data processing unit 114 receives the row image data RID2, the data processing unit 114 controls the control signal generating unit 116 to generate the polarity control signal POL and the latch signal LAT based on the row image data RID2. At this time, when the comparison result CR indicates that the row image data RID1 and RID2 are equal, the data processing unit 114 does not generate the row display data RDD2 based on the row image data RID2; when the comparison result CR indicates that the row image data RID1 and RID2 are not equal, the data processing unit 114 generates the row display data RDD2 based on the row image data RID2.

When the differential signal transmitter 117 receives the row display data RDD1 from the data processing unit 114, the differential signal transmitter 117 outputs the horizontal clock signal hCLK and the row display data (i.e., the row display data RDD1′) in the form of the differential signal, so as to transmit the row display data RDD1′ to the source driver 120. When the differential signal transmitter 117 receives the row display data RDD2 from the data processing unit 114, the differential signal transmitter 117 outputs the horizontal clock signal hCLK and the row display data (i.e., the row display data RDD2′) in the form of the differential signal, so as to transmit the row display data RDD2′ to the source driver 120.

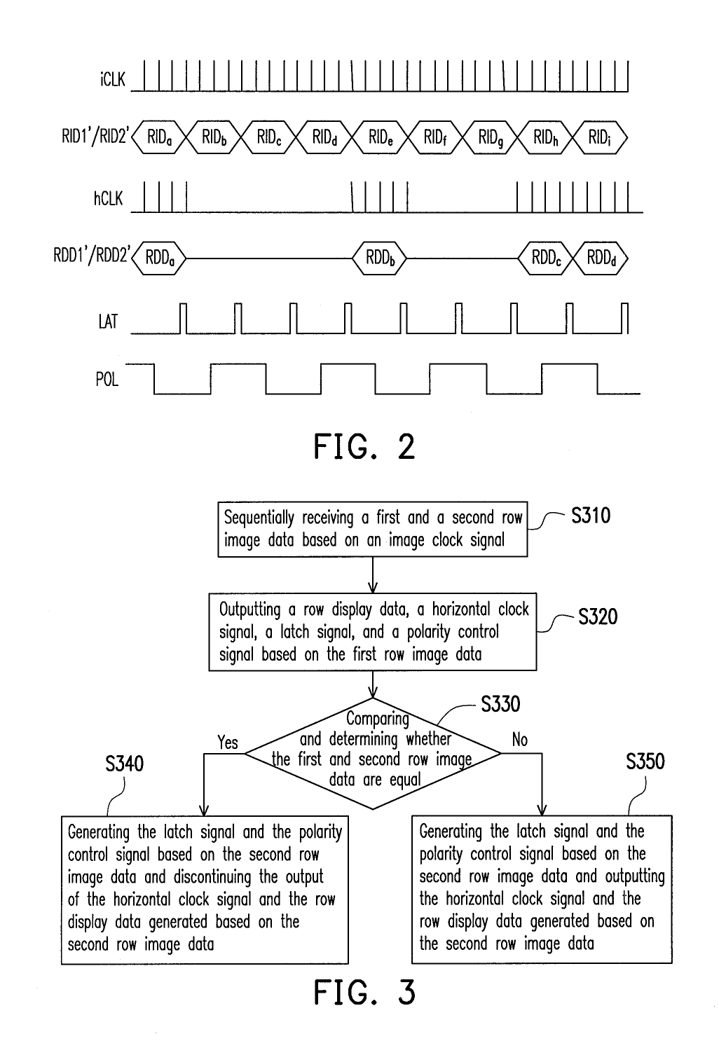

FIG. 2 is a schematic view illustrating timing of a timing controller in the display shown in FIG. 1A according to an embodiment of the invention. With reference to FIG. 1A and FIG. 2, the row image data RIDₐ are assumed to be the first data, and therefore there is no comparison result. Besides, the row image data RIDₐ˜RID_{d} are assumed to be equal, and the row image data RIDₑ˜RID_{g} are assumed to be equal. When the timing controller 110 receives the row image data RIDₐ based on the image clock signal iCLK, the timing controller 110 outputs the horizontal clock signal hCLK and the row display data RDDₐ based on the row image data RIDₐ and outputs the polarity control signal POL and the latch signal LAT. When the timing controller 110 receives the row image data RID_{b}˜RID_{d} based on the image clock signal iCLK, the timing controller 110 outputs the polarity control signal POL and the latch signal LAT. Because the row image data RID_{b}˜RID_{d} and the row image data RIDₐ are equal, the timing controller 110 does not outputted the horizontal clock signal hCLK and the row display data.

When the timing controller 110 receives the row image data RIDₑ based on the image clock signal iCLK, since the row image data RIDₑ and the row image data RID_{d} are not equal, the timing controller 110 outputs the horizontal clock signal hCLK and the row display data RDD_{b} based on the row image data RIDₑ and outputs the polarity control signal POL and the latch signal LAT. When the timing controller 110 receives the row image data RID_{f} and RID_{g} based on the image clock signal iCLK, the timing controller 110 outputs the polarity control signal POL and the latch signal LAT. Because the row image data RID_{f} and RID_{g} and the row image data RIDₑ are equal, the timing controller 110 does not outputted the horizontal clock signal hCLK and the row display data.

When the timing controller 110 receives the row image data RIDₕ based on the image clock signal iCLK, since the row image data RIDₕ and the row image data RID_{g} are not equal, the timing controller 110 outputs the horizontal clock signal hCLK and the row display data RDD_{c} based on the row image data RIDₕ and outputs the polarity control signal POL and the latch signal LAT. When the timing controller 110 receives the row image data RIDᵢ based on the image clock signal iCLK, since the row image data RID, and the row image data RIDₕ are not equal, the timing controller 110 outputs the horizontal clock signal hCLK and the row display data RDD_{d} based on the row image data RIDᵢ and outputs the polarity control signal POL and the latch signal LAT.

In view of the above, when the present row image data and the previous row image data are equal, the timing controller 110 does not outputted the horizontal clock signal hCLK and the row display data (e.g., RDDₐ˜RDD_{d}), thus reducing the power consumption of the timing controller 110.

FIG. 3 is a flowchart illustrating an operation method of a timing controller according to an embodiment of the invention. With reference to FIG. 3, in this embodiment, a first row image data and a second row image data are sequentially received based on the image clock signal (step S310). a row display data, a horizontal clock signal, a latch signal, and a polarity control signal are outputted based on the first row image data (step S320). The first row image data and the second row image data are compared to determine whether the first and second row image data are equal (step S330). When the first row image data and the second row image data are equal, i.e., the result of determining whether the first and second row image data are equal in step S330 is “Yes”, the latch signal and the polarity control signal are generated based on the second row image data, and the output of the horizontal clock signal and the row display data generated based on the second row image data discontinues (step S340). When the first row image data and the second row image data are different, i.e., the result of determining whether the first and second row image data are equal in step S330 is “No”, the latch signal and the polarity control signal are generated based on the second row image data, and the horizontal clock signal and the row display data generated based on the second row image data are outputted (step S350). The details of the steps are discussed in the embodiments shown in FIG. 1A, FIG. 1B, and FIG. 2 and thus will not be reiterated herein.

As described in the embodiments with respect to the display, the timing controller, and the operation method thereof, when the present row image data and the previous row image data are equal, the timing controller does not outputted the horizontal clock signal and the row display data based on the present row image data. As a result, the power consumption of the timing controller can be reduced.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A display comprising:
a display panel;
a timing controller receiving a first row image data and a second row image data for generating a row display data, a polarity control signal, and a latch signal based on the first row image data or the second row image data, wherein when the first row image data and the second row image data are equal, an output of the row display data generated based on the second row image data discontinues;
a gate driver coupled to the timing controller and the display panel for outputting a plurality of scan signals to the display panel; and
a source driver coupled to the timing controller and the display panel for outputting a plurality of pixel voltages to the display panel based on the row display data, the polarity control signal, and the latch signal.

2. The display as recited in claim 1, wherein the timing controller comprises:
a line buffer sequentially receiving the first row image data and the second row image data;
a data processing unit coupled to the line buffer for generating the row display data based on the first row image data or the second row image data;
a data comparing unit coupled to the line buffer for comparing the first row image data with the second row image data and outputting a comparison result, wherein when the first row image data and the second row image data are equal, the data processing unit, according to the comparison result, stops outputting the row display data generated based on the second row image data; and
a control signal generating unit coupled to the data processing unit, the control signal generating unit being controlled by the data processing unit to generate the latch signal and the polarity control signal.

3. The display as recited in claim 2, wherein the timing controller further comprises:
a data input latch coupled to the line buffer for determining whether the first row image data and the second row image data are inputted to the line buffer.

4. The display as recited in claim 2, wherein the first row image data, the second row image data, and the row display data are transmitted through a differential signal.

5. The display as recited in claim 4, further comprising:
a differential signal receiver receiving the first row image data and the second row image data in a form of the differential signal and outputting the first row image data and the second row image data to the line buffer; and
a differential signal transmitter receiving the row display data from the data processing unit and outputting a horizontal clock signal and the row display data in the form of the differential signal.

6. The display as recited in claim 5, wherein the differential signal receiver sequentially receives the first row image data and the second row image data in the form of the differential signal based on an image clock signal.

7. The display as recited in claim 5, wherein the source driver receives the row display data in the form of the differential signal based on the horizontal clock signal.

8. A timing controller comprising:
a line buffer sequentially receiving a first row image data and second a row image data;
a data processing unit coupled to the line buffer for generating a row display data based on the first row image data or the second row image data; and
a data comparing unit coupled to the line buffer for comparing the first row image data with the second row image data and outputting a comparison result to the data processing unit, wherein when the first row image data and the second row image data are equal, the data processing unit, according to the comparison result, stops outputting the row display data generated based on the second row image data.

9. The timing controller as recited in claim 8, further comprising:
a data input latch coupled to the line buffer for determining whether the first row image data and the second row image data are inputted to the line buffer.

10. The timing controller as recited in claim 8, wherein the first row image data, the second row image data, and the row display data are transmitted through a differential signal.

11. The timing controller as recited in claim 10, further comprising:
a differential signal receiver receiving the first row image data and the second row image data in a form of the differential signal and outputting the first row image data and the second row image data to the line buffer; and
a differential signal transmitter receiving the row display data from the data processing unit and outputting a horizontal clock signal and the row display data in the form of the differential signal.

12. The timing controller as recited in claim 8, wherein the differential signal receiver sequentially receives the first row image data and the second row image data based on an image clock signal.

13. The timing controller as recited in claim 8, further comprising:
a control signal generating unit coupled to the data processing unit, the control signal generating unit being controlled by the data processing unit to generate a latch signal and a polarity control signal.

14. An operation method of a timing controller, comprising:
sequentially receiving a first row image data and a second row image data;
outputting a row display data and a horizontal clock signal based on the first row image data;
comparing the first row image data with the second row image data;
discontinuing the output of the horizontal clock signal and the row display data generated based on the second row image data when the first row image data and the second row image data are equal; and
outputting the horizontal clock signal and the row display data generated based on the second row image data when the first row image data and the second row image data are not equal.

15. The operation method of the timing controller as recited in claim 14, further comprising:
generating a latch signal and a polarity control signal based on the first row image data and the second row image data.

16. The operation method of the timing controller as recited in claim 14, wherein the step of sequentially receiving the first row image data and the second row image data comprises:
sequentially receiving the first row image data and the second row image data based on an image clock signal.
